(19) United States
(12) Patent Application Publication
(10) Pub. No.: US 2007/0168568 A1
(43) Pub. Date: Jul. 19, 2007

(54) COMPUTER SYSTEM AND COMMUNICATION METHOD THEREOF WITH PERIPHERAL DEVICE

(75) Inventor: Cheng-Min Tsai, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,396

(22) Filed: Aug. 3, 2006

(30) Foreign Application Priority Data
Jan. 18, 2006 (CN) 200610033270.8

(51) Int. Cl. G06F 3/00

(52) U.S. Cl. 710/5

(57) ABSTRACT

A computer system includes a plurality of privileged commands, a global descriptor table, a section object, a callgate-creating module and a user program. The privileged commands is capable of communicating with a peripheral device connected to the computer system. The global descriptor table includes a spare descriptor that can be accessed by any user program having no privilege of directly calling the privileged commands. The section object is used for reading information from and writing information into the global descriptor table. The callgate-creating module is used for using the section object to create a callgate in the spare descriptor. The callgate indicates an entry of at least one of the privileged command. The user program having no privilege of directly calling the privileged commands can access the spare descriptor to call for said at least one privileged command via the callgate to communicate with the peripheral device.

### FIELD OF THE INVENTION

This invention relates to computer systems and, more particularly, to a computer system with a communication unit for communicating with a peripheral device and a communication method thereof.

### DESCRIPTION OF RELATED ART

Computer systems have become more and more popular in households and various industries due to their excellent performances in handling vast information. As the computer systems are developed to be more and more powerful, more and more peripheral devices are developed to connect to the computer systems so as to cooperate with the computer systems to perform specific tasks. In order to communicate with the peripheral devices, the computer systems are required to install corresponding device drivers thereon.

Generally, a computer system includes an operating system, such as Microsoft® Windows® operating system or Linux operating system. The operating system includes many commands. Some commands, which can cause the computer system to malfunction, such as clearing memory, are known as privileged commands, and the rest of the commands are known as non-privileged commands. In order to maintain security of the operating system, the operating system defines a kernel mode and a user mode for computer-executable programs. Kernel mode computer-executable programs have a higher privilege level and can call the privileged commands to access all resources of the computer system and any peripheral devices connected to the computer system. User mode computer-executable programs have a lower privilege level and can only call the non-privileged commands accessing limited resources of the computer system.

Usually, user programs are only executable in the user mode, thereby having the lower privilege level that cannot call the privileged commands. However, only the privileged commands can directly access a peripheral device that connects to the computer system. In order to have the user programs operate the peripheral device, a device driver that is installed in the kernel mode is needed. Take for example a user program such as Microsoft® Word, and a peripheral device such as a printer, in order to allow Microsoft® Word to use the printer to print a Microsoft® Word file, a corresponding printer driver is needed to call the privileged commands to access the printer.

However, the device driver is usually recorded on a medium that is separated from the peripheral device and is prone to being lost.

Therefore, a communicating method for the computer system that allow the computer system to communicate with the periphery device without installing the corresponding device driver is desired.

### SUMMARY OF THE INVENTION

A computer system includes a plurality of privileged commands, a global descriptor table, a section object, a callgate-creating module and a user program. The privileged commands is capable of communicating with a peripheral device connected to the computer system. The global descriptor table includes a spare descriptor that can be accessed by any user program having no privilege of directly calling the privileged commands. The section object is used for reading information from and writing information into the global descriptor table. The callgate-creating module is used for using the section object to create a callgate in the spare descriptor. The callgate indicates an entry of at least one of the privileged command. The user program having no privilege of directly calling the privileged commands can access the spare descriptor to call for said at least one privileged command via the callgate to communicate with the peripheral device.

A communication method is provided for a computer system to communicate with a peripheral device. The communication method includes steps of: creating a callgate in a global descriptor table via a section object; and calling a privileged command via the callgate to enable the computer system to communicate with the peripheral device.

A storage medium is provided for recording a computer-executable program. The computer-executable program includes a first code and a second code. The first code is used for creating a callgate in a global descriptor table via a section object. The second code is used for calling a privileged command via the callgate to enable the computer system to communicate with the peripheral device.

Other advantages and novel features will become more apparent from the following detailed description of preferred embodiments when taken in conjunction with the accompanying drawings, in which:

### BRIEF DESCRIPTION OF THE DRAWINGS

Many aspects of the present computer system and the present communication method thereof can be better understood with reference to the following drawings. The components in the drawings are not necessarily to scale, the emphasis instead being placed upon clearly illustrating the principles of the present disc drive. Moreover, in the drawings, like reference numerals designate corresponding parts throughout the several views.

FIG. 1 is a block diagram of a computer system, the multi-disc player including a disc tray; and

FIG. 2 is a flow chart illustrating a communication method of FIG. 1.

### DETAILED DESCRIPTION OF THE INVENTION

Reference will now be made to the drawings to describe the preferred embodiment of the present computer system and the present communication method, in detail.

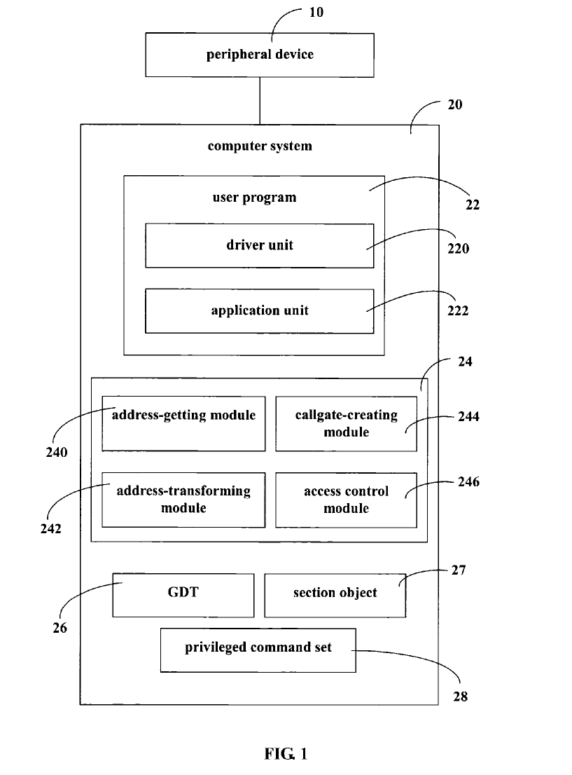

Referring to FIG. 1, a computer system 20 in accordance with an exemplary embodiment is connected to a peripheral device 10. An exemplary peripheral device can be a printer, a digital camera, or a debugging apparatus. The computer system 20 can be a personal computer.

The computer system 20 includes a user program 22, a communication unit 24, a global descriptor table (GDT) 26, a section object 27, and a privileged command set 28 which includes a plurality of privileged commands.

The user program 22 may be a word processing program such as Microsoft® Word, an image capturing program for the digital camera, or a debugging software for a debugging apparatus. The user program 22 includes a driver unit 220 and an application unit 222. The driver unit 220 is used for enabling the application unit 222 to communicate with the peripheral device 10. However, the driver unit 220 is in a user mode and cannot call anyone of the privileged commands of the privileged command set 28 to enable the application unit 222 to communicate with the peripheral device 10.

The GDT 26 is recorded in a physical memory (not shown) of the computer system 20, and is used for storing descriptors that indicate access privileges of computer programs to some data stored in the physical memory or entries of some specific programs or commands. The descriptors stored in the GDT 26 include program descriptors that define access privileges to data stored in the physical memory and gate descriptors that point to some specific programs or commands. An exemplary gate descriptor is a callgate that indicate an entry of some specific program or command.

The section object 27 is used for accessing descriptors stored in the GDT 26. Access rights of the section object 27 are recorded in an access control list (ACL). For security purposes, in a default state, the access rights of the section object 27 are “read only”.

The communication unit 24 is used for enabling the driver unit 220 to call the privileged command of the privileged command set 28. The communication unit 24 includes an address-getting module 240, an address-transforming module 242, a callgate-creating module 244, and an access control module 246.

The address-getting module 240 is used for getting a linear address of the GDT 26 in a linear address space of the computer system 20 via set global descriptor table (SGDT) instructions of the computer system 20. The linear address of the GDT 26 includes a directory pointer, a table pointer, and an offset pointer. The directory pointer indicates a base address of a page table stored in the linear address space. The table pointer points to an offset in the page table stored in the linear address space. The offset in the page table stored in the linear address space indicates an entry of a page table stored in a physical memory. The offset pointer indicates an offset in the page table stored in a physical memory. The offset in the page table stored in a physical memory indicates a physical address of the GDT 26.

The address-transforming module 242 is used for transforming the linear address of the GDT 26 into the physical address of the GDT 26.

The callgate-creating module 244 is used for searching for the GDT 26 in the physical memory based on the physical address of the GDT 26, and then for searching for a spare descriptor in the GDT 26 to create a callgate in the spare descriptor of the GDT 26 via the section object 27 The spare descriptor can be accessed by any programs in the user mode. Therefore, the user program 22 can access the spare descriptor. The callgate created in the spare descriptor points to an entry of one or more corresponding privileged command. Through the callgate, the user program can call the one or more corresponding privileged command of the privileged command set to communicate with the peripheral device 10.

The access control module 246 is used for modifying the access rights of the section object 27 from “read only” to “read” and “write” in the ACL.

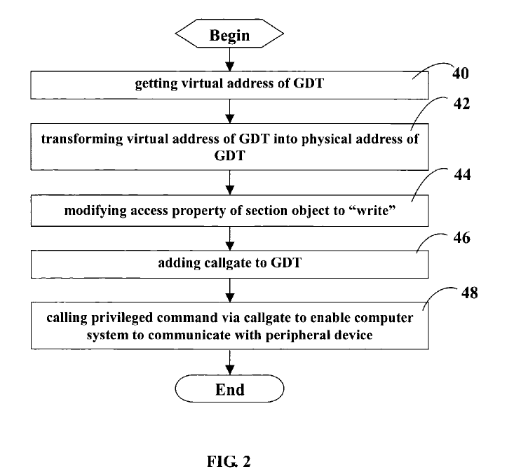

Referring to FIG. 2, a communication procedure of the computer system 20 is illustrated.

First, in step 40, the address-getting module 240 gets the linear address of the GDT 26 via the SGDT instructions.

Second, in step 42, the address-transforming module 242 transforms the linear address of the GDT 25 into the physical address of the GDT 26 via the linear transformation.

Third, in step 44, the access control module 246 modifies the access rights of the section object 27 from “read only” to “read” and “write” in the ACL.

Fourth, in step 46, the section object 27 seeks the GDT 26 based on the physical address of the GDT 26, searches for the spare descriptor and then creates the callgate in the spare descriptor of the GDT 26.

Fifth, in step 48, the driver unit 220 calls the one or more corresponding privileged command of the privileged command set 28 via the callgate. By executing the privileged command, the application unit 222 is enabled to communicate with the peripheral device 10.

The user program 22 uses the callgate to call the privilege command instead of a device driver. Therefore, a requirement for installing the device driver is eliminated.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A computer system, comprising:
a plurality of privileged commands, the plurality of privileged commands being capable of communicating with a peripheral device connected to the computer system;
a global descriptor table for recording descriptors indicating entries of the plurality of privileged commands, the global descriptor table having a spare descriptor that can be accessed by any user program having no privilege of directly calling the privileged commands to communicate with the peripheral device;
a section object for reading information from and writing information into the global descriptor table;
a callgate-creating module for using the section object to create a callgate in the spare descriptor, the callgate indicating an entry of at least one of the privileged commands; and
a user program having no privilege of directly calling the privileged commands, being used for accessing the spare descriptor to call for said at least one privileged command via the callgate to communicate with the peripheral device.

2. The computer system as claimed in claim 1, further comprising:
an address-getting module for getting a linear address of the global descriptor table; and
an address-transforming module for transforming the linear address of the global descriptor table into a physical address of the global descriptor table.

3. The computer system as claimed in claim 1, wherein the section object has only a “read” privilege to the global descriptor table.

4. The computer system as claimed in claim 3, further comprising an access control module for adding a “write” privilege to the section object so that the section object is capable of creating the callgate in the spare descriptor.

5. A communication method for a computer system to communicate with a peripheral device, the communication method comprising steps of:
creating a callgate in a global descriptor table via a section object; and
calling a privileged command via the callgate to enable the computer system to communicate with the peripheral device.

6. The communication method as claimed in claim 5, further comprising steps of:
getting a linear address of the global descriptor table; and
transforming the linear address into a physical address of the global descriptor table.

7. The communication method as claimed in claim 5, wherein the section object has only a “read” privilege to the global descriptor table.

8. The communication method as claimed in claim 7, further comprising a step of adding a “write” privilege to the section object so that the section object is capable of creating the callgate in the global descriptor table.

9. A storage medium for recording a computer-executable program, the computer-executable program comprising:
a first executable code configured for creating a callgate in a global descriptor table via a section object; and
a second executable code configured for calling a privileged command via the callgate to enable the computer system to communicate with the peripheral device.

10. The storage medium as claimed in claim 9, further comprising:
a third executable code configured for getting a linear address of the global descriptor table; and
a fourth executable code configured for transforming the linear address into a physical address of the global descriptor.

11. The storage medium as claimed in claim 9, further comprising a fifth executable code configured for adding a “write” privilege to the section object so that the section object is capable of creating the callgate in the global descriptor table.
